(19) United States
(12) Patent Application Publication
(10) Pub. No.: US 2003/0134979 A1
(43) Pub. Date: Jul. 17, 2003

(54) Heat-and-oil resistant polymer blends

(76) Inventors: Lorenzo Ferrari, Bright's Grove (CA); Janet N. Gamlin, Sarnia (CA)

Correspondence Address: BAYER CORPORATION, PATENT DEPARTMENT, 100 BAYER ROAD, PITTSBURGH, PA, 15205, US

(21) Appl. No.: 10/234,684

(22) Filed: Sep. 4, 2002

(30) Foreign Application Priority Data
Sep. 5, 2001 (CA) 2,356,580

(51) Int. Cl. C08F 8/30

(52) U.S. Cl. 525/178

(57) ABSTRACT

A conjugate is formed by blending a polyamide with a hydrogenated carboxylated nitrile rubber at elevated temperature. The conjugate is readily formable by molding or extrusion, and it displays excellent heat, oil-resistant and barrier properties that render it suitable for use, for example, in many automotive under-the-hood applications.

### FIELD OF THE INVENTION

The present invention relates to blends of thermoplastic elastomers having a conjugate formed by blending a polyamide with a hydrogenated carboxylated nitrile rubber at elevated temperature. The conjugate is readily formable by molding or extrusion, and displays excellent heat, oil-resistant and barrier properties that render it suitable for use, for example, in many automotive under-the-hood applications.

### BACKGROUND OF THE INVENTION

Thermoplastic elastomers find many applications, for example in coatings, adhesives and in molded and extruded parts. The latter are valued for their toughness and impact resistance, and find application in automotive parts, mechanical parts, electrical parts and other uses.

Improvements in properties are being constantly sought, and often for this purpose polymeric materials are mixed or blended. The present invention is directed to heat-and oil-resistant materials with good barrier properties, and to processes for their manufacture.

EP-A1-0 364 859 relates to vulcanizable rubbery compositions containing a polyamide, a partially hydrogenated nitrile rubber and curatives in the nitrile rubber. The partially hydrogenated nitrile rubber, admixed with a curing agent, was gradually added to molten polyamide, with mixing. It is stated that it is preferred to use a polyamide having a low melting point, such as nylon 12. In a preferred embodiment the composition includes maleic anhydride or succinic anhydride. The specification states that the anhydride additive improves mixing between the nylon and the rubber compound. Better results are obtained in an example in which maleic anhydride is used, but the properties of the product obtained are not particularly good, and are not adequate for commercial use.

U.S. Pat. No. 4,508,867 relates to vulcanizable rubbery compositions containing a crystalline polyamide, a synthetic rubbery polymer composed of acrylonitrile or methacrylonitrile, an α,β-unsaturated carboxylic acid and butadiene, an additive selected from the halides of lithium, magnesium, calcium and zinc, an additive selected from the oxides and hydroxides of magnesium, calcium, barium and zinc and the peroxides of calcium and zinc and further contains sulfur vulcanization active agents. Nylon 11 is the only polyamide whose use is exemplified.

The descriptive portion of the specification suggests that the mixing of the polyamide and the synthetic rubbery polymer should take place at a temperature in the range of from about 500 to about 125° C. In Examples 1 and 2 mixing of nylon 11 and carboxylated nitrile rubber, and other ingredients, took place at 50° C. In Example 3 mixing took place at 190 to 199° C. and Example 4 does not specify the temperature of mixing.

It is believed that the compositions of U.S. Pat. No. 4,508,867 do not display adequate heat resistant properties.

### SUMMARY OF THE INVENTION

The present invention provides a process, which includes blending a polyamide with a hydrogenated carboxylated nitrile rubber at a temperature above 20° C. to form a conjugate.

The present invention also provides a conjugate, or composite, of a polyamide and a hydrogenated carboxylated nitrile rubber.

The conjugates of the present invention display some properties that are enhanced, as compared with corresponding properties of the polyamide, and some properties that are enhanced, as compared with corresponding properties of the hydrogenated carboxylated nitrile rubber. The conjugates of the present invention display good heat-and oil-resistant properties and excellent barrier properties. These properties render the conjugates of the present invention useful, for example, for containing volatile fuels such as gasoline in fuel hoses, fuel tanks, shields, fuel line and delivery hoses, inner lines for tires and industrial bladders and the like. Another advantage of the conjugates of the present invention is that they are recyclable. Excess or scrap conjugate material can be melted for re-molding or re-extruding, for example, with no significant deterioration in properties. In this important characteristic it differs from most elastomers, which are not recyclable. Furthermore, the conjugates of the present invention have a lower specific gravity than 100% hydrogenated carboxylated nitrile rubber. Accordingly, less of the conjugate, by weight is needed to make a particular part, resulting in a material cost saving.

### DETAILED DESCRIPTION OF THE INVENTION

Polyamides useful in the present invention include homopolymers and copolymers that have repeated amide linkages along a polymer chain. The polyamides are preferably of high molecular weight and are crystalline or glossy polymers. Examples include polycaprolactam (nylon 6), polylaurolactam (nylon 12), polyhexamethyleneadipamide (nylon 6,6), polyhexamethyleneazelamide (nylon 6,9), polyhexamethylenesebacamide (nylon 6,10), polyhexamethyleneisophthalamide (nylon 6,IP), polyaminoundecanoic acid (nylon 11), polytetramethyleneadipamide (nylon 4,6) and copolymers of caprolactam, hexamethylenediamine and adipic acid (nylon 6,66), and also aramids such as polyparaphenyleneterephthalamide. The majority of the polyamides have softening points and melting points in the range of from 160° to 250° C.

Hydrogenated carboxylated nitrile rubbers (HXNBR) and processes for making them are not known in the art and are the subject of WO 2001/77185, which is assigned to Bayer Inc. Such rubbers are formed by copolymerizing at least diene monomer, preferably a conjugated diene, at least one nitrile monomer, at least one unsaturated acid monomer and optionally further copolymerizable monomers, to form a copolymer with a random, or statistical, distribution of repeating units derived from the diene, nitrile, acid and optionally further co-monomers, followed by hydrogenation. When the, preferably conjugated, diene is polymerized the product contains some carbon-carbon double bonds. In the past attempts to hydrogenate those carbon-carbon double bonds have led to reduction of nitrile and carboxyl groups, which is undesirable. The invention of WO 2001/77185 enables hydrogenation of carbon-carbon double bonds of carboxylated nitrile rubber without concomitant reduction of nitrile and carboxyl groups, yielding novel and valuable polymers. These polymers are commercially available from Bayer under the trademark Therban XT.

Many, preferably conjugated, dienes can be used in the hydrogenated carboxylated nitrile rubber, such as 1,3-butadiene, isoprene, 2,3-dimethyl-1,3-butadiene, 1,3-pentadiene and piperylene, of which 1,3-butadiene is preferred.

The nitrile monomer can be acrylonitrile, methacrylonitrile or α-chloroacrylonitrile, of which acrylonitrile is preferred.

The unsaturated acid can be α,β-unsaturated, and can be, for example, acrylic, methacrylic, ethacrylic, crotonic, maleic (including in the form of its anhydride), fumaric or itaconic acid, of which acrylic and methacrylic are preferred.

The conjugated diene usually constitutes in the range of from 50 to 85% of the polymer, the nitrile usually constitutes in the range of from 15 to 50% of the polymer and the acid in the range of from 0.1 to 10%, preferably 0.5 to 7%, these percentages being by weight. The polymer may also contain an amount, usually not exceeding 10 wt. %, of another copolymerizable monomer, for example, an ester of an unsaturated acid, such as ethyl, propyl or butyl acrylate or methacrylate, or a vinyl compound, for example, styrene, α-methylstyrene or a corresponding compound bearing an alkyl substitutent on the phenyl ring, for instance, a p-alkylstyrene such as p-methylstyrene. The values of the repeating units given above will have to be adjusted accordingly to result in a total of 100 wt. %. The polymer preferably is a solid that has a molecular weight in excess of 60,000, more preferably in excess of 100,000 g/mol.

The degree of hydrogenation can be expressed in terms of residual double bonds (RDB), being the number of carbon-carbon double bonds remaining after hydrogenation, expressed as a percentage of the carbon-carbon double bonds prior to hydrogenation. HXNBR's with RDB less than 6 are preferred and HXNBR's with RDB in the range from 0.9 to 5.5 are more preferred. Preferred acrylonitrile contents are 32%, 33%, 34%, 36%, 39% and 43% (all by weight).

In one embodiment of the process of the present invention, the polyamide is melted and HXNBR is then added to the melt, with stirring in an intensive mixer such as a Banbury or in a high-shear extruder. The mixing is preferably in a single step and is preferably without curatives. The mixing temperature can range from 150° C. to 300° C., preferably from 170° C. to 270° C., and more preferably from 200 to 250° C., depending upon the polyamide grade. The fill factor, i.e., the volume of material being mixed, expressed as a percentage of the volume of the mixing vessel, is preferably in the range from 50% to 95%, preferably 65 to 80%, more preferably 55 to 75% with higher fill factors resulting in blends with better physical properties. The mixer is preferably used at, or close to its maximum RPM (95 rpm) to ensure good dispersion of the elastomer within the polyamide matrix.

Nylon 6, for example, melts at a relatively high temperature in the range of 225° C., and the molten nylon 6 may be at a temperature of in the range of 240° C. If held at this temperature for any length of time HXNBR may degrade, so it is preferred to minimize the time at this temperature. An antioxidant may also be included in the mixture, suitably in an amount up to 1.5 phr, preferably 0.7 phr. The mixture is stirred and if the torque required to drive the stirrer is plotted against time it is found that the torque increases with time. This indicates bonding or crosslinking between the polyamide and the hydrogenated carboxylated nitrile rubber. When the torque ceases to increase this indicates that crosslinking has substantially ceased, and also that mixing is complete.

As indicated, an antioxidant may be used in the mixing process. Examples of suitable antioxidants include p-dicumyl diphenylamine (Naugard® 445), Vulkanox® DDA (a diphenylamine derivative), Vulkanox® ZMB2 (zinc salt of methylmercapto benzimidazole), Vulkanox® HS (polymerized 1,2-dihydro-2,2,4-trimethyl quinoline) and Irganox® 1035 (thiodiethylene bis(3,5-di-tert.-butyl-4-hydroxy) hydrocinnamate or thiodiethylene bis(3-(3,5-di-tert.-butyl-4-hydroxyphenyl)propionate supplied by Ciba-Geigy. Vulkanox is a trademark of Bayer AG.

It is possible to achieve further crosslinking. Thus, when the torque ceases to increase a crosslinking agent can be added, while mixing continues. The crosslinking agent can be a peroxide crosslinking agent, a diamine crosslinking agent, a phenolic resin or sulfur or a sulfur containing crosslinking agent. It may also be desired that the conjugate have good high temperature properties, and sulfur curing tends to have a deleterious effect on high temperature properties. Therefore sulfur-curing agents will not generally be used, but their use is not outside the scope of the invention.

Useful peroxide crosslinking agents, including dicumyl peroxide, di-tert.-butyl peroxide, benzoyl peroxide, 2,2′-bis (tert.-butylperoxy diisopropylbenzene (Vulcup® 40KE), benzoyl peroxide, 2,5-dimethyl-2,5-di(tert-butylperoxy)-hexyne-3,2,5-dimethyl-2,5-di(benzoylperoxy)hexane, (2,5-bis(tert.-butylperoxy)-2,5-dimethyl hexane and the like. The high temperature of the polyamide melt influences the selection. Preferred curing agents are readily determined by means of a few preliminary experiments, which is within the scope of one skilled in the art. A preferred peroxide curing agent is commercially available under the trademark Vulcup® 40KE. The peroxide curing agent is suitably used in an amount of 0.2 to 7 parts per hundred parts of rubber (phr), preferably 1 to 3 phr. Too much peroxide may lead to undesirably violent reaction.

Diamine crosslinking agents that can be used include aliphatic diamines, for example α,ω alkylene diamines such as 1,6-hexamethylenediamine and cycloaliphatic diamines such as 1,4-cyclohexanediamine. A source of 1,6-hexamethylenediamine is hexamethylenediamine carbamate, available under the trademark DIAK 1. The diamine crosslinking agent is suitably used in an amount of 0.2 to 20 phr, preferably 1 to 10 phr.

Phenolic resins such as bromoethylated alkyl phenol-formaldehyde resin known as SP 1055 or alkyl phenol-formaldehyde resin (SP 1045) in the presence of a halide activating agent such as stannis chloride, Lewis Acid or Neoprene W will also result in effective crosslinking. These are supplied by Schenectady International and can be used in level of 1 to 10, preferably 5 to 7 phr.

Vulcanizing co-agents can also be used. Mention is made of triallyl isocyanurate (TAIC), commercially available under the trademark DIAK 7 from DuPont Or N,N′-m-phenylene dimaleimide know as HVA-2 (DuPont Dow), triallyl cyanurate (TAC) or liquid polybutadiene known as Ricon D 153 (supplied by Ricon Resins). Amounts can be equivalent to the peroxide curative or less, preferably equal.

Crosslinking density can further be increased by the addition of an activator such as zinc peroxide (50% on an inert carrier) using Struktol ZP 1014 in combination with the peroxide. Amounts can be between 0.2 to 7 phr, preferably 1 to 3 phr.

The ratio of polyamide to hydrogenated carboxylated nitrile rubber can vary between wide limits, preferably from 90 parts to 10 parts by weight to 10 parts to 90 parts by weight. Properties of the conjugate vary, depending on the ratio of polyamide to elastomer. A conjugate of 30 parts polyamide and 70 parts elastomer was flexible and was suitable for use in flexible hoses for use, for example, as fuel lines. A 50:50 conjugate was hard and a 70:30 conjugate was like a plastic, and acceptable for rigid fuel lines but not flexible ones. The ratio can of course be varied to optimize particular properties, and tests of conjugates of different proportion can be carried out routinely by persons skilled in the art.

It is possible to include processing oils and extenders or plasticizers in the conjugate. Suitable plasticizers include those well known for use with nitrile polymers such as the phthalate compounds, the phosphate compounds, the adipate compounds, the alkyl carbitol formal compounds, the coumarone-indene resins and the like. An example is the plasticizer commercially available under the trademark Plasthall 810, or Plasthall TOTM (trioctyl trimellitate) or TP-95 (di-(butoxy-ethoxy-ethyl) adipate supplied by Morton Intentional. The plasticizer should be a material that is stable at high temperature and will not exude from the conjugate. If a plasticizer is to be used it is preferred to melt the polyamide, add a first portion of the hydrogenated carboxylated nitrile rubber, say about half, mix, then add the plasticizer, mix and then add the remainder of the HXNBR and continue mixing. The amount of plasticizer used will depend upon the proposed end use of the conjugate, but may be between 1 and 40 phr, preferably between 5 and 20 phr. It is further possible to use a blend of polyamides. It is also possible to use a mixture of HXNBR's or a mixture of the HXNBR and another elastomer, for example a carboxylated nitrile rubber (XNBR), a hydrogenated nitrile rubber (HNBR) or a nitrile rubber (NBR), a vinyl acetate rubber (EVM) or a ethylene/acrylate rubber (AEM). Suitable XNBR's are commercially available from Bayer under the trademark Krynac and suitable HNBR's are commercially available from Bayer under the trademark Therban and suitable NBR's are available from Bayer under the trademark Perbunan. EVM is commercially available from Bayer under the trademark Levapren. Vamac® D an ethylene acrylic elastomer is commercially available from (DuPont. If the HXNBR is used in admixture with another elastomer it is preferred that the HXNBR shall be at least 25%, preferably at least 50%, of the HXNBR-elastomer mixture.

It is possible to incorporate other known additives or compounding agents in the conjugate. These are preferably added after the blending of the polyamide and HXNBR. Additives include reinforcing fillers, for example carbon black, white fillers, calcium carbonate, clay, nanoclay (such as Cloisite 15A supplied by Southern Clay Products), silica or talc, calcium carbonate, antioxidants, antiozonants, processing oils, ultra violet absorbers, heat stabilizers, co-agents and the like.

The conjugate of the invention sets, of course, to form a solid on cooling. The conjugate can be re-melted and re-solidified without any significant deterioration or deleterious effect on its properties. In this respect, it differs from elastomers such as pure HXNBR, XNBR, HNBR and the like; after crosslinking these cannot be melted and resolidified. This property of the conjugate of the invention is important. It permits the conjugate of the invention to be made into the form of pellets, which pellets can be re-melted to be formed into final products by, for example, molding or extrusion. It is also possible to recycle conjugate of the invention, which is a very significant commercial advantage of the invention.

The invention is further illustrated but is not intended to be limited by the following examples in which all parts and percentages are by weight unless otherwise specified.

### EXAMPLES

General Procedure

A Brabender Plasticorder was fitted with roller mixing blades and a 369 g capacity bowl. Mixer bowl temperature, fill factor, mixing time and roller speed were varied. In a typical mixing procedure polyamide was initially melted (at 20° C. higher than the polyamide melting point, followed by addition of elastomer and, in some instances, fillers and processing oils, and a cure system. The polymer blend was then passed through a 70° C. mill once to make a flat sheet.

A Preco Press was used to compression mould test pieces. The compound was added to a pre-heated mould and placed in the press at 0 psi at 240° C. for 10 minutes. The mould was then held at 20,000 psi for 20 minutes, after which the molded sample was transferred to a cold press and held at 10,000 psi for 5 min.

The polyamide used was Durethan® B31SK polyamide 6, supplied by Bayer AG. B31 SK is an unreinforced polyamide with low crystallinity. It has the following desirable properties:

high strength, stiffness and abrasion resistance

good chemical and stress-cracking resistance

vicat softening point>200° C.; melting point˜225° C.

good barrier properties

Additional polyamides used in the invention and supplied by Bayer included Durethan® B 30 S (melting point 225° C.), Durethan® Cl 31 F (mp 190° C.) and Durethan® C 38 F (mp 210° C.).

As HXNBR there was used a Therban® XT that has carboxyl moieties, based on acrylic acid, of approximately 5.0%, an acrylonitrile content of 33%, the balance 1,3-butadiene, a Mooney viscosity of 77 and an RDB of 3.5%. As HNBR's there were used Therban® A3406 and Therban® C3446, Therban® A3406 has an acrylonitrile content of 34% and an RDB % not greater than 0.9, Therban® C3446 has an acrylonitrile content of 34% and an RDB of 4%.

### Example 1 (Comparative)

70 Parts (phr—per hundred rubber) of HNBR (Therban® A3406 or Therban® C3446) and 30 parts of polyamide 6 (Durethan® B 31SK) were blended in the presence of 0.7 phr of antioxidant Naugard® 445, a peroxide cure system, namely 5.3 phr of Vulcup 40KE and 1.1 phr of TAIC and 0.5 phr of antioxidant Irganox 1035 (thiodiethylene bis(3,5-di-t-butyl-4-hydroxy) hydrocinnamate or thiodiethylene bis(3-(3,5-di-t-butyl-4-hydroxyphenyl)propionate supplied by Ciba-Geigy. The Brabender mixing conditions were as follows:

55% fill factor;

80 RPM mixing blade speed;

230° C. bowl temperature;

12 min total mixing time.

Results are given in Table 1.

TABLE 1
Room temperature physical properties for 70:30 phr
Therban ®: Polyamide 6 blends (Peroxide/Coagent)

| | Tensile | | | |
|---|---|---|---|---|
| Therban ® | Strength | Ultimate | Tensile | Hardness |
| grade | (MPa)* | Elongation (%)** | set (%)*** | (Sh. A)**** |
| A3406 | 2.24 | 489 | >100 | 60 |
| C3446 | 1.95 | 337 | na | 64 |

*ASTM D 412
**ASTM D 412
***ASTM D 412-98
****ASTM D-2240

### Example 2

HXNBR (Therban® XT, 70 parts) and polyamide 6 (Durethan® B31SK, 30 parts), with no curatives, were blended. The polyamide was melted and the HXNBR and 0.7 phr of an antioxidant (Naugard® 445) were then added. It was observed that mixing torque would increase for a period of about three minutes and then reach an equilibrium level, at which time mixing was stopped. Results are given in Table 2.

TABLE 2
Room temperature physical properties for 70:30 phr
Therban ® XT: Polyamide 6 blends with no curatives; mixing
conditions were varied

| | Tensile Strength | Ultimate | Tensile set | Hardness |
|---|---|---|---|---|
| Run | (MPa) | Elongation (%) | (%) | (Sh. A) |
| A | 9.5 | 165 | N/A | 78 |
| B | 8.5 | 350 | 35 | 62 |
| C | 7.1 | 216 | 16 | 67 |

The product of these runs show a tensile strength greater than 7 MPa, ultimate elongation greater than 100% and tensile set less than 50%. The best results were achieved in run B, in which mixing was done with a high fill factor (70%), fast RPM (95) and high temperature (240° C.).

When runs similar to runs A, B and C were carried out but using an HNBR in place of the HXNBR, no increase in mixing torque was observed in the absence of a curing system, suggesting that there was no interaction between the HNBR and the polyamide. This contrasts with the situation when HXNBR and polyamide are blended.

The products of runs A, B and C were heat aged in an air-oven at 150° C. for 168 hours or for 504 hours, and properties measured. For comparison peroxide-cured Therban® A3406 was heat aged and its properties measured. Results are given in Table 3.

TABLE 3
Heat-aged physical properties for 70:30 phr
Therban ® XT: Polyamide 6 blends with no curatives; aging
temperature was 150° C.

| | | Change in | Ultimate | |
|---|---|---|---|---|
| | Aging Time | Tensile Strength | Elongation | Hardness |
| Run | (h) | (%) | (%) | (Sh. A) |
| A | 504 | 6 | −44 | −9 |
| B | 168 | 84 | −44 | −7 |
| C | 168 | 82 | −30 | −9 |

TABLE 4
Heat-aged physical properties for 100 phr Therban ® peroxide-
cured optimized for heat resistance; aging temperature was 150° C.

| | | | | |
|---|---|---|---|---|
| A3406 | 168 | 5 | −34 | 9 |
| A3406 | 504 | −34 | −83 | 20 |

These results show that the long term heat aging performance of the products of runs A, B and C exceed that of Therban® A3406, with good retention of physical properties such as tensile strength and ultimate elongation at high temperature. The brittle point for the product of run B exceeded −72° C.

In contrast, the product of blending regular HNBR (Therban® A3406) with polyamide in the absence of a curing system melted when attempt was made to heat-age it at 150° C.

The permeability of the product of run C was measured and found to be 3.5 (cm²/(atm·s))×10⁸, which compares favorably with the permeability of 3 of a typical bromobutyl cured tire inner-liner.

The products of runs A, B and C were all re-processable. Molded test pieces were cut and re-molded several times without any evidence of gel material. The products had excellent flow properties at molding temperatures, for example 240° C.

### Example 3

In this example HXNBR (Therban® XT, 70 parts) and polyamide 6 (Durethan® B31 SK, 30 parts) and 0.7 phr antioxidant (Naugard® 445) were blended in the presence of a 2.2 to 5.3 phr of peroxide curing agent Vulcup® 40KE (2,2′-bis(tert.-butylperoxy)diisopropylbenzene), and 1.1 or 2.2 phr of triallylisocyanurate coagent (DIAK 7, available from DuPont). Mixing conditions were kept constant at 95 RPM, 240° C. and 65% fill factor (Table 5).

Results are given in Table 5.

TABLE 5
Room temperature physical properties for 70:30 phr
Therban ®: Polyamide 6 blends with peroxide cure system

| | | | Tensile | Ultimate | Tear | Hard- |
|---|---|---|---|---|---|---|
| | Vulcup ® | DIAK ® 7 | Strength | Elongation | Strength | ness |
| Run | (phr) | (phr) | (MPa) | (%) | (kN/m) | (Sh. A) |
| D | 2.2 | 1.1 | 7.6 | 266 | 24 | 59 |
| E | 2.2 | 2.2 | 9.0 | 332 | 28 | 60 |
| F | 3.3 | 2.2 | 7.8 | 344 | 21 | 61 |
| G | 5.3 | 1.1 | 7.1 | 274 | 28 | 68 |

### Example 4

HXNBR (Therban® XT, 70 parts) and polyamide 6 (Durethan® B31SK, 30 parts) and 0.7 phr antioxidant (Naugard® 445) were blended with 0.05 to 0.3 phr of bifunctional curing agent, namely hexamethylenediamine, DIAK 1.

Results are given in Table 6. Run I is comparative, as there is used an HNBR, not an HXNBR.

TABLE 6
Room temperature physical properties for 70:30 phr
Therban ®: Polyamide 6 blends with DIAK 1 cure system; various
mixing conditions*

| | | | | Ulti- | | | |
|---|---|---|---|---|---|---|---|
| | | | | mate | | | |
| | Ther- | | Tensile | Elon- | Tear | Hard- | Tensile |
| | ban ® | DIAK 1 | Strength | gation | Strength | ness | Set |
| Run | Grade | (phr) | (MPa) | (%) | (kN/m) | (Sh. A) | (%) |
| H^{a} | XT | .2 | 8.3 | 109 | 58.3 | 76 | 15 |
| I^{a} | A3406 | .2 | 4.6 | 45 | 33.6 | 77 | 6.7 |
| J^{b} | XT | .2 | 7.8 | 140 | 42.0 | 74 | 12 |
| K^{b} | XT | .3 | 7.8 | 104 | 64.4 | 76 | 10 |
| L^{a} | XT | .1 | 8.5 | 242 | ND | 76 | −ND |
| M^{a} | XT | .05 | 8.1 | 205 | −ND | 75 | 19 |
| N^{c} | XT | .08 | 9.5 | 288 | −ND | 71 | 27 |

Mixing conditions:

a=240° C., 95 RPM, 70% fill factor; DIAK 1 added after 8 min mix time. Total mix time was 9 minutes.

b=230° C., 95 RPM, 67% fill factor; DIAK 1 added after 8 min mix time. Total mix time was 9 minutes.

c=240° C., 95 RPM, 70% fill factor; DIAK 1 added once polymer blend torque was minimized (approx. 5 minutes into mix). Total mix time was 8 minutes.

ND not determined

### Example 5

HXNBR (Therban® XT, 70 parts) and polyamide 6 (Durethan® B31SK, 30 parts) and 0.7 phr antioxidant (Naugard® 445) were blended. In runs O and P there were used 2.2 phr Vulcup® 40KE and 2.2 phr DIAK® 7, added after 7 minutes of mixing.

An amount of 0.15 phr antioxidant Irganox 1035 was added at the end of the reaction. The mixing conditions in runs O, P and Q were: temperature 240° C.; speed 95 RPM; fill factor 70%; total mixing time 8 minutes. Compound N contained 0.08 phr of Diak 1 as the curative, which was added after 7 minutes. The oil resistance of the formed conjugates in ASTM Oil 1 and IRM 903 was then measured. ASTM Oil 1 is a blend of aromatics. IRM 903 is a blend of naphthenics and paraffinics. The blends were heat-aged at 150° C. for 168 hours in ASTM Oil 1 and IRM 903 and the results are given in Table 7 and 8, respectively.

TABLE 7
Heat aging results for selected Therban ® XT/polyamide 6 blends
at 150° C. for 168 hours in ASTM Oil 1.

| | | Tensile | | Hard- | | |
|---|---|---|---|---|---|---|
| Com- | | Strength | Ultimate | ness | Weight | Volume |
| pound | Cure | (% | Elongation | (Sh. A | Change | Change |
| Number | System | change) | (% change) | change) | (%) | (%) |
| O | Peroxide | 38 | −1 | −2 | −0.7 | 0.3 |
| P | Peroxide | 41 | 2 | 1 | −1.4 | −1.4 |
| Q | None | 118 | 40 | 8 | 0.4 | 1.6 |
| N | DIAK 1 | 77 | −17 | 5 | 0.4 | 1.3 |
| HNBR | Peroxide | 18 | −33 | 1 | −2.1 | −2.4 |
| Control | | | | | | |

The blends cured using Peroxide, O and P, exhibited the best overall performance i.e. retention of physical properties and had minimal weight and volume change after oil-immersion aging. The tensile strength of all the blends increased during aging whereas the elongation values varied depending on the cure system. The oil resistance of the blends is comparable to the HNBR control.

TABLE 8
Heat aging results for selected Therban ® XT/polyamide 6 blends
at 150° C. for 168 hours in IRM 903.

| Com- | | Tensile | Ultimate | | Weight | Volume |
|---|---|---|---|---|---|---|
| pound | Cure | Strength | Elongation | Hardness | Change | Change |
| Number | System | (%) | (%) | (Sh. A) | (%) | (%) |
| O | Peroxide | −36 | −34 | −10 | 15.6 | 18.1 |
| P | Peroxide | −37 | −ND | −5 | 14.7 | 15.9 |
| Q | None | 36 | 8 | −5 | 17.9 | 20.3 |
| N | DIAK 1 | −17 | −39 | −4 | 17.9 | 20.3 |
| HNBR | Peroxide | −20 | −24 | −8 | 14.6 | 17.9 |
| Control | | | | | | |

The IRM 903 oil resistance of the TPE blends is comparable to the Therban® A3406 peroxide cured reference formulation. All blends had a decrease in hardness and an increase in weight and volume after the testing.

### Example 6

The polyamide 6 (Durethan® C 38 F, 30 phr) was melted first (2 min) at 240° C., followed by the addition of HXNBR (Therban® XT, 70 phr) and 1.5 phr of Naugard® 445. The curatives were added after 5 minutes at 2.2 phr of peroxide Vulcup® 40 KE, 2.2 phr of coagent TAIC or HVA 2 and 2.2 phr of zinc peroxide in compounds R to T. Diak 1 (0.05 phr) was added in R to T after 6 minutes. The total mixing time was 7 minutes. The resin (SP 1055) was added at a level of 7 phr after 7 minutes and reaction stopped after 9 minutes.

TABLE 7
Room temperature physical properties for 70:30 phr Therban ®:
Polyamide 6 blends with and without zinc peroxide in the
presence of peroxide cure systems or phenolic resin

| | | Tensile | Ultimate | |
|---|---|---|---|---|
| Compound | | Strength | Elongation | Hardness |
| Number | Curatives | (MPa)* | (%)** | (Sh. A)*** |
| R | Peroxide | 5.98 | 368 | 60 |
| | TAIC | | | |
| | Diak 1 | | | |
| S | Peroxide | 9.96 | 321 | 69 |
| | TAIC | | | |
| | Diak 1 | | | |
| | ZP 1014 | | | |
| T | Peroxide | 9.25 | 289 | 71 |
| | HVA 2 | | | |
| | Diak 1 | | | |
| | ZP 1014 | | | |
| U | Resin SP 1055 | 8.69 | 384 | 63 |

### Example 7

The polyamide 6 (Durethan® C 38 F, 30 phr) was melted first (2 min) at 240° C., followed by the addition of HXNBR (Therban® XT, 70 phr) or Therban® XT (35 phr) with Therban® A3406 (35 phr) or Therban® XT (50 phr) with Levapren® 700 HV (20 phr) and 0.7 phr of Naugard® 445. The curatives were added after 5 minutes at 2.2 phr each of peroxide Vulcup® 40 KE , coagent TAIC or HVA 2 and zinc peroxide in compounds V to X. Diak 1 (0.05 phr) was added in compound V to X after 6 minutes. The total mixing time was 7 minutes. Compounds V and X also contain 0.5 phr of processing aid Armeen D.

TABLE 9
Room temperature physical properties for 70:30 phr Therban ®
XT/Therban ® or /Levapren ® with Polyamide 6 blends peroxide cured

| | | Tensile | Ultimate | |
|---|---|---|---|---|
| Compound | | Strength | Elongation | Hardness |
| Number | Therban ® | (MPa)* | (%)** | (Sh. A)*** |
| V | XT (70 phr) | 12.23 | 329 | 72 |
| W | XT/A3406 | 10.45 | 278 | 67 |
| | (35/35) | | | |
| X | XT/Levapren | | | |
| | 700 HV | 12.25 | 301 | 71 |
| | (50/20) | | | |

### Example 8

A mix was made by adding Therban® XT (70 phr), antioxidant Naugaurd 445 (1.5 phr), Stearic Acid (1 phr) and either fillers Vulkasil A1 (10 phr) with Silane A 172 DLC (72%) (0.5 phr) or Carbon Black N660 (10 phr) to a 6×12 inch mill at 30° C. at 55 rpm for 11 minutes. Curatives at 2.2 phr each of peroxide Vulcup® 40 KE, coagent TAIC or HVA 2 and zinc peroxide and 0.05 phr of Diak 1 were added at the second stage and milled for 3 minutes at the same temperature. The polyamide 6 (Durethan® C 38 F, 30 phr) was melted in the Brabender (2 min) at 240° C., followed by the addition of the mix. The reaction was completed after 7 minutes.

TABLE 10
Room temperature physical properties for 70:30 phr Therban ®
XT with Polyamide 6 blends peroxide cured with fillers

| | | Tensile | Ultimate | |
|---|---|---|---|---|
| Compound | | Strength | Elongation | Hardness |
| Number | Filler | (MPa)* | (%)** | (Sh. A)*** |
| Z | None | 22.43 | 425 | 87 |
| AA | White Filler | 19.92 | 318 | 88 |
| AB | Black Filler | 15.59 | 294 | 87 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the preparation of a conjugate comprising the step of blending a polyamide with a hydrogenated carboxylated nitrile rubber at a temperature above 20° C.

2. A process according to claim 1 wherein the polyamide is polyamide 6.

3. A process according to claim 1 wherein the hydrogenated carboxylated nitrile rubber is a copolymer of acrylonitrile, butadiene and acrylic acid, having a residual carbon-carbon double bond content of 6% or less.

4. A process according to claim 1 wherein the temperature is in the range of from 150 to 300° C.

5. A process according to claim 1 wherein the blending is carried out in a means for mixing with a fill factor in the range 50 to 95%.

6. A process for the preparation of a conjugate comprising the steps of melting a polyamide and adding a hydrogenated carboxylated nitrile rubber to the molten polyamide, with stirring and in the absence of any curative system.

7. A process according to claim 6 further comprising the set of adding a curing system, wherein the curing system is added with the mixing torque ceases to increase.

8. A process for the preparation of a conjugate comprising the steps of melting a polyamide and adding a hydrogenated carboxylated nitrile rubber and a curing system to the molten polyamide.

9. A process according to claim 8 wherein the curing system is a peroxide curing system, a diamine curing system, a phenolic resin curing system, or a mixture thereof.

10. A process according to claim 9 wherein the curing system is a zinc peroxide.

11. A process for the preparation of a conjugate comprising the steps of blending a polyamide with a hydrogenated carboxylated nitrile rubber at a temperature above 20° C. then pelletizing the blend.

12. A conjugate of a polyamide and a hydrogenated carboxylated nitrile rubber.

13. A conjugate according to claim 12 that has been formed with the aid of a curing agent.

14. A conjugate according to claim 12 further comprising a hydrogenated nitrile rubber, ethylene vinyl acetate rubber, ethylene acrylate polymer or a mixture thereof.

15. A pellet comprised of a conjugate according to claim 12.

16. A mold comprised of a conjugate according to claim 12.

17. An extruded part comprised of a conjugate according to claim 12.
